(19) United States
(12) Patent Application Publication
(10) Pub. No.: US 2026/0298882 A1
(43) Pub. Date: Oct. 1, 2026

(54) ROBOTIC CONTINUOUSLY SCANNING LASER VIBROMETER SYSTEM FOR VIBRATION MEASUREMENT AND MODAL IDENTIFICATION OF A STRUCTURE

(71) Applicant: UNIVERSITY OF MARYLAND, BALTIMORE COUNTY, Baltimore, MD (US)

(72) Inventors: Weidong ZHU, Baltimore, MD (US); Ke Yuan, Baltimore, MD (US); Jingkun Gao, Baltimore, MD (US)

(21) Appl. No.: 19/634,435

(22) Filed: Mar. 31, 2026

Related U.S. Application Data
(60) Provisional application No. 63/781,422, filed on Apr. 1, 2025.

(51) Int. Cl. G01N 29/24; B25J 15/00; G01M 5/00; G01N 29/12; G01N 29/265; G01N 29/44

(52) U.S. Cl. CPC G01N 29/2418; B25J 15/0019; G01M 5/0066; G01N 29/12; G01N 29/265; G01N 29/4463; G01N 2291/0289; G01N 2291/2698

(57) ABSTRACT

A continuously scanning laser Doppler vibrometer (CSLV) has been widely used to measure structural vibrations due to its high measurement efficiency and spatial resolution. However, a conventional CSLV, which conducts continuous scanning through two rotating scan mirrors, is limited by its field of view. A robotic CSLV system is described herein that combines a robotic arm and a laser vibrometer to provide a more flexible approach to obtaining modal parameters of a structure.

### CROSS REFERENCE TO RELATED APPLICATIONS

This application claims priority to U.S. Provisional Patent Application No. 63/781,422 filed on Apr. 1, 2025 in the name of Weidong ZHU et al. entitled “DEVELOPMENT OF A ROBOTIC CONTINUOUSLY SCANNING LASER DOPPLER VIBROMETER SYSTEM FOR VIBRATION MEASUREMENT AND MODAL IDENTIFICATION OF A BEAM,” both of which are hereby incorporated by reference herein in their entirety.

### STATEMENT OF FEDERALLY SPONSORED RESEARCH

This invention was made with government support under Grant No. CMMI-1763024 awarded by the National Science Foundation. The government has certain rights in the invention.

### FIELD

The present invention relates to a robotic continuously scanning laser vibrometer (CSLV) system and method of using same. The robotic CSLV system is capable of measuring structural vibrations through continuous robotic motion instead of traditional rotating scan mirrors, and extends the measurement field of view beyond that of a conventional mirror-based CSLDV system.

### BACKGROUND

A continuously scanning laser Doppler vibrometer (CSLDV) is a vibration measurement device with high efficiency and non-contact capability [1, 2]. The CSLDV technique has been widely used to obtain modal parameters of structures in various engineering applications, such as model updating [3, 4], vibration monitoring of infrastructures [5], and structural damage detection [6-8]. The CSLDV was developed by adding a pair of orthogonal scan mirrors in front of a single-point laser Doppler vibrometer (LDV), providing an automated way to measure vibrations at multiple points on a structure. The major difference between the CSLDV and a scanning laser Doppler vibrometer (SLDV) is that scan mirrors in the CSLDV continuously rotate to scan the laser spot along a path on the structure, while those in the SLDV move the laser spot in a point-by-point manner. Therefore, the CSLDV can provide a much faster means of obtaining the vibration response of the structure than the SLDV. However, the response measured by the CSLDV is a combination of vibration signals and spatial deflection due to the scanning motion and the moving measurement location, which requires new signal processing methods to identify the modal parameters of the structure. Several methods have been developed for CSLDV measurements under sinusoidal or impact excitation, such as the polynomial method [9], demodulation method [10], and lifting method [11]. These methods have recently been improved or extended to process responses from CSLDV measurements under more realistic excitations, such as random excitation [12-14].

As an optical-based device, the laser vibrometer, including LDV, SLDV, and CSLDV, has a limited field-of-view (FOV) and cannot measure vibrations in areas outside of it. Various studies have been conducted to develop advanced measurement methodologies to extend the FOV of the laser vibrometer. Two common methods are moving the laser vibrometer to different positions [15] and using a reflective mirror to redirect the laser beam of the laser vibrometer [16-18]. The first method involves building a global coordinate system using reference objects and reconstructing vibrations of different areas based on that system. However, measurement errors can be introduced during the repositioning of the device, and the method becomes less feasible as the number of measurement surfaces increases due to strict experimental setup requirements. The second method keeps positions of both the laser vibrometer and the test structure unchanged to minimize movement errors, redirecting the laser beam to otherwise unmeasurable areas via reflective mirrors. The present inventors previously developed a novel mirror-assisted testing methodology [17], including a new algorithm to design continuous and synchronous scan trajectories using mirrored areas, and a new signal processing method that stitches vibration signals from different parts of the structure using mirrored laser heads for three-dimensional (3D) CSLDV measurements. Although this method supports measurements of structures with complex surfaces, such as cylindrical ones, it requires mirrors of appropriate sizes and carefully placed orientations, which can significantly increase experimental duration.

Using robotic platforms such as unmanned aerial vehicles (UAVs) or robotic arms to assist structural health monitoring has received growing attention due to the increased flexibility and accessibility they provide. For example, UAV-assisted crack detection methods have been developed using image processing techniques for bridges with ongoing traffic [19]. UAV-based digital image correlation systems [20, 21] have also been developed to capture dynamic responses of large infrastructures. Mounting a laser vibrometer on a programmable moving platform like a UAV or robotic arm offers a promising approach to overcoming limitations of traditional vibration measurement systems. By inputting programmed positions and orientations into the UAV or the robotic arm, the laser spot can be directed accurately to desired positions on the structure, avoiding manual movement errors. For example, UAV+LDV solutions have been proposed and correction methods developed to compensate for angular and linear movement errors [22, 23]. Other studies have demonstrated the application of robot+LDV systems for vibration measurements in industrial scenarios, such as damage detection in composite plates and model updating of bladed wheels [24-27]. In these studies, large industrial robotic arms were often used to accommodate multiple laser heads for full-field 3D vibration measurements, which increased space and cost requirements. A 3D robot+LDV system using only one laser head was proposed to reduce the payload requirement of the robotic arm to 3 kg, making the system more compact and suitable for laboratory environments [28]. However, existing robot-assisted LDV systems have primarily focused on step-by-step measurements, and there is a lack of studies on integrating robotic arms with the CSLDV technique to significantly increase measurement efficiency.

Towards that end, the present invention relates to a system and method of use that integrates the use of a robotic arm with the CSLDV system. Advantageously, using the system and method of using same, an extended FOV can be obtained compared to conventional CSLDV systems using scanning mirrors. Further, because robotic motion introduces noise close to zero frequency in the measurement signal, a new method is disclosed to accurately extract structural vibration signals that can subsequently be demodulated to obtain a mode shape. The 1D mode shapes obtained can be processed by a baseline-free damage detection method to identify locations of damage in the structure.

### SUMMARY

In one aspect, a robotic continuously scanning laser vibrometer (CSLV) system is described, said system comprising:
a robotic arm;
a laser vibrometer mounted on the robotic arm; and
a central control and data acquisition (DAQ) system.

In another aspect, a method of obtaining a mode shape of a structure using a robotic CSLV system is described, wherein the robotic CSLV system comprises a robotic arm, a laser vibrometer mounted on the robotic arm, and a central control and DAQ system, said method comprising:
scanning a vibrating structure using the robotic CSLV system, wherein the laser vibrometer is translated along a straight line on a surface of the structure to obtain a measured response of the structure under sinusoidal excitation;
separating the measured response to isolate a low-frequency laser head motion signal from a high-frequency structure vibration signal using a notch filter;
extracting the structure vibration signal to obtain its mode shape.

Other aspects, features and embodiments of the invention will be more fully apparent from the ensuing disclosure and appended claims.

### BRIEF DESCRIPTION OF THE FIGURES

FIG. 1A. An embodiment of a proposed novel robotic CSLDV system, comprising a six-axis robotic arm and a compact laser vibrometer.

FIG. 1B. An embodiment of the working principle of the robotic CSLDV system, where the robotic arm, the laser vibrometer, and the modal shaker are synchronized by a central control and a DAQ system.

FIG. 2A. An embodiment of the working principle of the central control and DAQ system.

FIG. 2B. A schematic of the switch and trigger signals for the modal shaker, the laser vibrometer, and the robotic arm, used to synchronously control all three components.

FIG. 3A. An example of a scan path executed by the system described herein along a straight line on the surface of a beam.

FIG. 3B. A time series of rotation angles of robotic arm joints J1-J6 corresponding to the straight-line path.

FIG. 4A. Measured responses of the beam without excitation.

FIG. 4B. Measured responses of the beam under sinusoidal excitation at 66.67 Hz.

FIG. 5A. First mode shape of the beam identified from the response shown in FIG. 4B using the conventional demodulation method.

FIG. 5B. The frequency spectrum of the measured response, displaying two dominant peaks at 0.25 Hz and 66.67 Hz

FIG. 6A. Separated signals using notch filters applied to the time domain response of the beam, where the top subplot shows the beam vibration and the bottom subplot shows the laser head motion.

FIG. 6B. Separated signals using notch filters applied to the frequency domain response of the beam, where the top subplot shows the beam vibration and the bottom subplot shows the laser head motion.

FIG. 6C. The first mode shape of the beam identified using the NFED method.

FIG. 7A. Experimental setup of vibration measurement of the beam using the robotic CSLDV system in its initial position, where the laser beam is parallel to the beam surface.

FIG. 7B. The test position of the robotic CSLDV system, where the arrow indicates its scan direction.

FIG. 8A. Vibration signals of the beam measured over five complete scans.

FIG. 8B. Vibration signal averaged from one complete scan, used to extract the mode shape of the beam using the NFED method.

FIG. 8C. First mode shapes of the beam identified using the robotic CSLDV system, the conventional CSLDV, and the point-by-point method.

FIG. 8D. MAC values among the identified mode shapes.

FIG. 9A. Consistency between forward and backward scans in a scan period at scan speeds of 274 mm/s. (b) 548 mm/s, (c) and 1096 mm/s, respectively,

FIG. 9B. Consistency between forward and backward scans in a scan period at scan speeds of 548 mm/s.

FIG. 9C. Consistency between forward and backward scans in a scan period at scan speeds of 1096 mm/s.

FIG. 9D. Identified mode shapes of the beam for three running speeds of the robotic CSLDV system, corresponding to scan frequencies of 0.25 Hz, 0.5 Hz, and 1 Hz.

FIG. 10. Extracted peak values of frequency spectra for five complete scans at scan frequencies of 0.25 Hz, 0.5 Hz, and 1 Hz.

FIG. 11. The robotic CSLDV system comprising the laser vibrometer, the central control and DAQ system, and further comprising a two-axis galvanometer unit and a camera imaging unit.

FIG. 12A. Measured responses of the beam specimen under sinusoidal excitation at 80 Hz.

FIG. 12B. Time series of coordinates of the two-axis galvanometer corresponding to the straight-line path.

### DETAILED DESCRIPTION, AND PREFERRED EMBODIMENTS THEREOF

Although the claimed subject matter will be described in terms of certain embodiments, other embodiments, including embodiments that do not provide all of the benefits and features set forth herein, are within the scope of this disclosure as well. Various structural and parameter changes may be made without departing from the scope of this disclosure.

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent to those described herein can be used in practice or testing of the present disclosure. All publications, patent applications, patents, and other references mentioned herein are incorporated by reference in their entirety. The materials, methods, and examples disclosed herein are illustrative only and not intended to be limiting.

“About” and “approximately” are used to provide flexibility to a numerical range endpoint by providing that a given value may be “slightly above” or “slightly below” the endpoint without affecting the desired result, for example, +/−5%.

The phrase “in one embodiment” or “in some embodiments” as used herein does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the invention.

The terms “comprise(s),” “include(s),” “having,” “has,” “can,” “contain(s),” and variants thereof, as used herein, are intended to be open-ended transitional phrases, terms, or words that do not preclude the possibility of additional acts or structures. The singular forms “a,” “and” and “the” include plural references unless the context clearly dictates otherwise. The present disclosure also contemplates other embodiments “comprising,” “consisting of” and “consisting essentially of,” the embodiments or elements presented herein, whether explicitly set forth or not.

As referred to herein, the term laser vibrometer system should be broadly construed. This system may include continuously scanning laser Doppler vibrometer systems and continuously scanning laser vibrometer systems. Such systems can measure the vibration in terms of velocity or displacement of a surface. It can do so by employing laser technology using or not using the Doppler shift principle to provide non-contact measurements.

As used herein, “sinusoidal excitation” which a single, controlled frequency, and hence is different from “random excitation,” which uses a broad spectrum of frequencies simultaneously. The present application does not relate to the measurement of random vibrations.

As used herein, a “structure” includes, but is not limited to, a beam (or beam-like) or a plate (or plate-like). As defined herein, a “beam” or “beam-like” can be any structure that has a length that is substantially greater than the cross-sectional dimensions of the beam structure, for example, wherein the length is at least two times, at least three times, at least five times, at least ten times, at least fifteen times, at least twenty times, at least 25 times, at least 30 times, at least 40 times, at leave 50 times, at least 60 times, at least 70 times, at least 80 times, at least 90 times, at least 100 times, or more, greater than the cross-sectional dimensions of the beam structure. As defined herein, a “plate” or “plate-like” can be any structure wherein the thickness, or depth, z is substantially less than the length x and/or the width y of the plate, for example, wherein the thickness, or depth, z is at least two times, at least three times, at least five times, at least ten times, at least fifteen times, at least twenty times, at least 25 times, at least 30 times, at least 40 times, at leave 50 times, at least 60 times, at least 70 times, at least 80 times, at least 90 times, at least 100 times, or more, less than the length x and/or the width y of the plate. It should be appreciated by the person skilled in the art that the structure can be made of any material known in the art including, but not limited to, metals, alloys, polymers, wood, concrete and other aggregates. In some embodiments, the structure materials are reinforced. It should be appreciated by the person skilled in the art that a plate-like or beam-like structure comprises at least one surface residing in the same plane, e.g., an o-xy plane. In other words, the plate-like or beam-like structure has at least one surface that is flat (or has no curvature).

As referred to herein, the terms “computing/processing device” should be broadly construed and may include any type of computing device, for example, a server, a desktop computer, a laptop computer, a smart phone, a cell phone, a pager, a personal digital assistant (PDA, e.g., with GPRS NIC), a mobile computer with a smartphone client, or the like.

As defined herein, depending on the size and material properties of the structure, “high frequency” can correspond to frequencies in the range of about 4000 Hz to about 10000 Hz.

As defined herein, depending on the size and material properties of the structure, “low frequency” can correspond to frequencies in the range from about 0 Hz to about 1500 Hz.

As used herein, a “low-pass filter” allows frequencies below a certain cutoff to pass while attenuating higher frequencies, and hence is different from a “bandpass filter,” which allows a specific band of frequencies to pass, rejecting those both above and below that band.

As used herein, the “laser head” corresponds to the combination of the robotic arm with the laser vibrometer mounted thereon.

As used herein, a “baseline-free” damage detection corresponds to conditions where baseline information from undamaged structures, e.g., beams, are not available or not obtained.

Broadly, a robotic CSLV system for structural vibration measurement is described herein. The system comprises a robotic arm, e.g., a six-axis robotic arm, and a compact laser vibrometer mounted on the robotic arm, and a central control and data acquisition system. The major difference between the robotic CSLV system described herein and the conventional CSLV lies in the scanning mechanism—in the conventional CSLV, the laser head is stationary and the laser spot moves via rotating scan mirrors, whereas in the robotic CSLV system, the laser head and the laser spot move together through joint rotations of the robotic arm. In some embodiments, the robotic CSLV system is a robotic CSLDV system because the laser vibrometer is a laser Doppler vibrometer.

According, in a first aspect, a robotic continuously scanning laser vibrometer (CSLV) system is described, said system comprising:
a robotic arm;
a laser vibrometer mounted on the robotic arm; and
a central control and data acquisition system.

In some embodiments, the “robotic arm” can be a six-axis robotic arm, which is an articulated electromechanical manipulator comprising six rotational joints connected in series, each joint providing one independent degree of freedom, collectively enabling the end effector to achieve any arbitrary position and orientation within the arm's reachable workspace. The six joints are conventionally designated J1 through J6, arranged from base to wrist. The first three joints (J1 (or axis 1), J2 (or axis 2), J3 (or axis 3)) establish the gross spatial positioning of the wrist center point. The remaining three joints (J4 (or axis 4), J5 (or axis 5), J6 (or axis 6 or “end”)) control the angular orientation of the “wrist” of the robot arm. The “end” of the robotic arm is the robot's terminal mounting flange, which serves as the mechanical interface for attaching an end-effector, brackets (or adapters), and/or other devices. In addition, or alternatively, an end-effector, can be attached to the J6 “end” and the end-effector can comprise means to attach brackets and/or other devices. Each joint is independently actuated by its own motor. This six-degree-of-freedom architecture provides complete spatial dexterity, allowing the user to position a tool or workpiece at a specified point in three-dimensional space while independently controlling the approach angle about all three rotational axes. The arm structure comprises rigid link segments fabricated from aluminum alloy, steel, or carbon fiber composite, engineered to balance structural stiffness with minimal inertia. Payload capacity, reach envelope, repeatability, and maximum joint velocities are primary performance specifications. In some embodiments, the laser vibrometer is mounted to the J6 or “wrist” of the robotic arm.

Although reference is to a six-axis robotic arm, it should be appreciated by the person skilled in the art that other robotic arms are contemplated including, but not limited to, (i) four- and five-axis arms, which although eliminating one or more wrist degrees of freedom, have less mechanical complexity, a lower cost, and less control overhead where full six-axis orientation control is unnecessary; (ii) Selective Compliance Assembly Robot Arms (SCARA); (iii) Delta robots; (iv) collaborative robots (cobots); and (v) seven-axis arms, which add a seventh rotational joint, allowing the user to achieve a given end-effector pose through multiple joint configurations, improving obstacle avoidance and dexterity in constrained environments.

Previous research has shown that speckle noise is a major factor affecting the quality of vibration measurements using moving laser vibrometers. To mitigate this factor, in some embodiments, a chip-based laser vibrometer with real-time speckle compensation is used to obtain vibration responses with reduced noise and improved quality. In some embodiments, the laser vibromer is a laser Doppler vibrometer and hence the In some embodiments, the laser vibrometer is attached directly to the mounting flange at the end of the robotic arm. In some embodiments, the laser vibrometer is attached to a mounting bracket, fixture assembly, or adapter, which is attached to the end of the robotic arm. In some other embodiments, the laser vibrometer is attached to an end-effector which is attached to the end of the robotic arm.

The robotic CSLV system is used to measure a response of a vibrating structure. Accordingly, in some embodiments, the vibrations of the structure are induced using a modal shaker, wherein the vibrations are effected using sinusoidal excitation. In some embodiments, the modal shaker comprises an element to attach the structure thereto. In some embodiments, the element includes, but is not limited to, screw clamps, spring clamps, clamping grips, clamping jaws, threaded fasteners, and any of attachment means that will secure the structure to the modal shaker.

In some embodiments, the robotic CSLV system further comprises a galvanometer unit, such as a two-axis galvanometer unit, and a camera imaging unit. In some embodiments, both the laser vibrometer unit and the galvanometer unit are attached to a mounting bracket, fixture assembly, or adapter, which is attached to the end of the robotic arm. In some embodiments, the laser vibrometer unit is attached directly to the mounting flange at the end of the robotic arm and the galvanometer unit is attached to a mounting bracket, fixture assembly, or adapter, which is attached to the end of the robotic arm. In some embodiments, the galvanometer unit is attached directly to the mounting flange at the end of the robotic arm and the laser vibrometer unit is attached to a mounting bracket, fixture assembly, or adapter, which is attached to the end of the robotic arm. It should be appreciated that instead of being attached to the end of the robotic arm, the laser vibrometer unit and the galvanometer unit can instead be attached to an end-effector which is attached to the end of the robotic arm. Although not shown, in some embodiments, the camera imaging unit is incorporated onto the same mounting flange at the end of the robotic arm, with or without a mounting bracket, fixture assembly, or adapter, or the camera imaging unit is attached to the end-effector assembly, or camera imaging unit is positioned elsewhere, depending on the implementation. In some embodiments, when the robotic CSLV system further comprises the galvanometer unit and the camera imaging unit, no modal shaker is needed.

In some embodiments, the central control and DAQ system comprises electronics to control the laser vibrometer, the robotic arm, a modal shaker (when present), a galvanometer unit (when present) and a camera imaging unit (when present). In some embodiments, when the robotic CSLV system comprises a robotic arm, a laser vibrometer mounted on the robotic arm, and a modal shaker, the central control and DAQ system comprises a switch block, which controls data to the modal shaker via a digital-to-analog (DAC) converter, wherein the modal shaker is disabled when the switch block passes zero signals and the modal shaker vibrates when the switch block passes sinusoidal excitation signals. In some embodiments, the central control and DAQ system sends a digital pulse as a trigger signal near the start of testing, wherein the laser vibrometer is triggered by the falling edge of the pulse, while the robotic arm is triggered by the rising edge of the pulse. In other words, the movement of the robotic arm, data acquisition of the laser vibrometer, and excitation provided by a modal shaker are synchronized by the central control and DAQ system.

In one embodiment of the first aspect, the robotic CSLV system is a robotic CSLDV system and comprises:
a robotic arm;
a laser Doppler vibrometer mounted on the robotic arm; and
a central control and data acquisition system.

In another embodiment of the first aspect, the robotic CSLV system comprises:
a robotic arm;
a laser vibrometer mounted on the robotic arm;
a modal shaker; and
a central control and data acquisition system.

In some embodiments, the laser vibrometer is a laser Doppler vibrometer and the system is a robotic CSLDV system.

In yet another embodiment of the first aspect, the robotic CSLV system comprises:
a robotic arm;
a laser vibrometer mounted on the robotic arm;
a galvanometer unit mounted on the robotic arm;
a camera imaging unit, optionally mounted on the robotic arm; and
a central control and data acquisition system.

In some embodiments, the laser vibrometer is a laser Doppler vibrometer and the system is a robotic CSLDV system.

The robotic CSLV system of the first aspect can be used to measure structural vibrations through continuous robotic motion instead of traditional rotating scan mirrors. The robotic arm is programmed to move the laser vibrometer continuously along a prescribed scan path on the structure so that vibration data can be collected with high spatial resolution and greater flexibility. The robotic CSLV system extends the measurement field of view beyond that of a conventional mirror-based CSLDV system. The robotic CSLV has been experimentally validated for vibration measurement and modal identification of a structure, and the identified mode shapes show high agreement with reference measurements. Advantageously, the robotic CSLV system described herein provides a continuous-scanning alternative to existing point-by-point robot-assisted laser vibrometry methods.

Towards that end, in a second aspect, a method of obtaining a mode shape using the robotic CSLV system of the first aspect is described, said method comprising:
scanning a vibrating structure using the robotic CSLV system, wherein the laser vibrometer is translated along a straight line on a surface of the structure to obtain a measured response of the structure under sinusoidal excitation;
separating the measured response to isolate a low-frequency laser head motion signal from a high-frequency structure vibration signal using a notch filter;
extracting the structure vibration signal to obtain its mode shape.

In some embodiments, the CSLV system is a CSLDV system. In some embodiments, the structure is a beam structure. In some other embodiments, the structure is a plate structure. In some embodiments, the robotic CSLV system scans at least a portion of a surface of the structure using a one-dimensional (1D) scan scheme.

In some embodiments, the structure is intentionally vibrated by attaching the structure to a modal shaker to vibrate the structure prior to scanning. The vibrating is effected using sinusoidal excitation.

In some embodiments, during scanning, the laser vibrometer is translated along a straight line on the surface of the beam at a constant speed in a range of about 274 mm/s to about 1096 mm/s. In some embodiments, the speed of translation is less than half the speed limit of the robotic arm. In some embodiments, the scan frequency is in a range of about 0.25 Hz to about 1 Hz. In some embodiments, a complete scan corresponds to the laser spot moving from a start point to an end point and then returning to the start point. In some embodiments, during vibration measurement, a distance between the laser head and the surface of the test beam remains constant during scanning.

In some embodiments, during scanning, the central control and DAQ system captures both a low-frequency motion of the laser vibrometer and a high-frequency vibration of the structure.

The conventional demodulation method for conventional CSLV measurements has limited accuracy when applied to signals from the robotic CSLV system, due to low-frequency interference introduced by the motion of the laser head. Accordingly, a notch-filter-enhanced demodulation (NFED) method to identify modal parameters of structures under sinusoidal excitation is described herein. The NFED method can separate vibration signals of a structure from motion signals of the laser vibrometer in the measured response and extract mode shapes of the structure. In some embodiments, NFED comprises the application of notch filters to the measured response obtained by scanning a vibrating structure using the robotic CSLV system, to isolate the low-frequency laser head motion from high-frequency beam vibration. With the beam vibration signal filtered, its mode shape can be accurately extracted using a demodulation method, as known to a skilled person in the art. This NFED enhancement therefore addresses limitations of the conventional demodulation approach for the robotic CSLDV system. In some embodiments, the NFED method to identify modal parameters of a structure under sinusoidal excitation comprises using a notch filter to separate a measured response of the structure under sinusoidal excitation into a low-frequency laser head motion signal and a high-frequency structure vibration signal, wherein the laser head comprises a robotic arm and a laser vibrometer.

In some embodiments, the robotic CSLV system further comprises a galvanometer unit, e.g., a two-axis galvanometer unit, mounted on the robotic arm and a camera imaging unit, optionally mounted on the robotic arm. In some embodiments, the galvanometer unit is controlled so that a laser beam continuously moves over the surface of the structure along positions corresponding to the target pixel trajectory, while the laser vibrometer acquires vibration response signals in real time during scanning. Advantageously, the galvanometer unit provides fast local beam steering within a given robot pose, enabling rapid continuous scanning over a smaller area.

It is known in the art that dynamic behavior of a structure can be affected by a damage in it, and one can detect the occurrence of a damage by studying the dynamic behavior of the structure. Modal parameters, such as damped natural frequencies and undamped mode shapes, of the structure are used to describe its dynamic behavior, which are useful for damage detection. Modal parameters of a structure can be estimated by modal analysis, which includes experimental modal analysis (EMA) and operational modal analysis (OMA). EMA requires excitation measurement while OMA does not; thus OMA is more appropriate for a structure under an operational condition or under random excitation. Different damage detection methods have been developed based on modal analysis. Different OMA methods have been developed to process responses from CSLDV measurements of structures to estimate their modal parameters, including natural frequencies, damping ratios, and mode shapes, and operational deflection shapes (ODSs) [10, 12, 34-37]. A demodulation method and a polynomial method were developed to estimate ODSs of a structure subject to sinusoidal excitation [10, 34]. Estimated ODSs and their curvatures (CODSs) of a beam under sinusoidal excitation can be used for identifying a damage in it via a novel damage detection method with a curvature damage index (CDI) [32]. A method can be baseline-free using a polynomial with a proper order to fit ODSs of the structure from the demodulation method is used to simulate an associated undamaged structure.

Accordingly, once a mode shape is obtained using the method of the second aspect, said mode shape can be used in a method of detecting damage in a structure, said method comprising using the mode shape obtained, using the robotic CSLV system, to identify damage to the structure, as understood by the person skilled in the art. In some embodiments, the damage is detected using a baseline-free method.

The present subject matter described in the first or second aspect may be a system, a method, and/or a computer program product. In some embodiments, the computer program product may include a computer readable storage medium (or media) having computer readable program instructions thereon for causing a processor to carry out aspects of the present subject matter.

In some embodiments, the computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a RAM, a ROM, an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

In some embodiments, computer readable program instructions described herein can be downloaded to respective computing/processing devices from a computer readable storage medium or to an external computer or external storage device via a network, for example, the Internet, a local area network, a wide area network and/or a wireless network, or Near Field Communication. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

In some embodiments, computer readable program instructions for carrying out operations of the present subject matter may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++, Javascript or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present subject matter.

In some embodiments, the computer readable program instructions may be provided to a processor of a computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. In some embodiments, the computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

In some embodiments, the computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

Accordingly, in a third aspect, a computer program product comprising a computer readable storage medium having program instructions embodied therewith is described, the program instructions executable by a computing device to cause the computing device to obtain and calculate a mode shape of a structure using the robotic CSLV system of the first aspect by:
controlling the robotic arm comprising the laser vibrometer to scan a surface of a structure to obtain a measured response of the structure under sinusoidal excitation;
separating the measured response to isolate a low-frequency laser head motion signal from a high-frequency structure vibration signal; and
extracting the structure vibration signal to obtain its mode shape.

### Example 1

### 1. Methodology

### 1.1 System Description

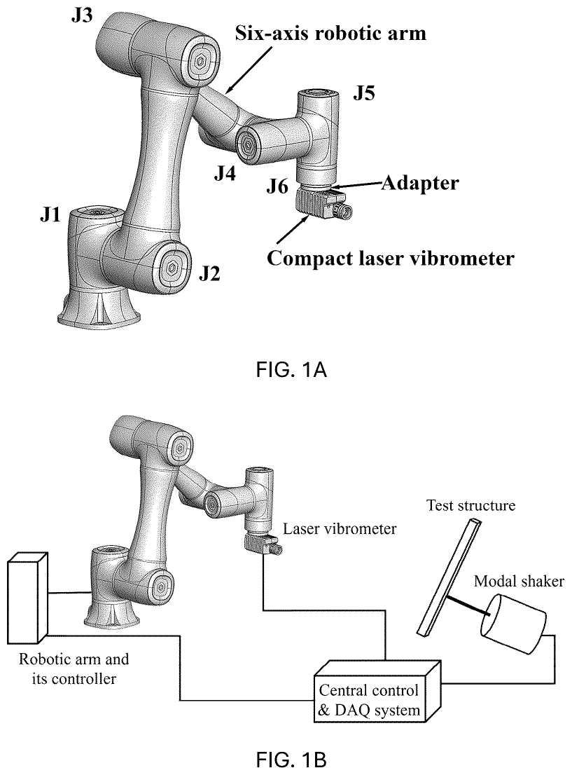

As shown in FIG. 1A, the proposed system consists of a compact laser vibrometer and a six-axis robotic arm, which are connected via an adapter. Six joints of the robotic arm, from its base to its tip, are denoted as J1-J6, and each can be independently controlled by an internal motor. In some embodiments, the laser vibrometer is attached to the “end” of the robotic arm. In some other embodiments, the laser vibrometer is attached to an end-effector, which is attached to the “end” of the robotic arm. During vibration measurement, the movement of the robotic arm, data acquisition of the laser vibrometer, and excitation provided by a modal shaker are synchronized by a central control and DAQ system, as shown in FIG. 1B.

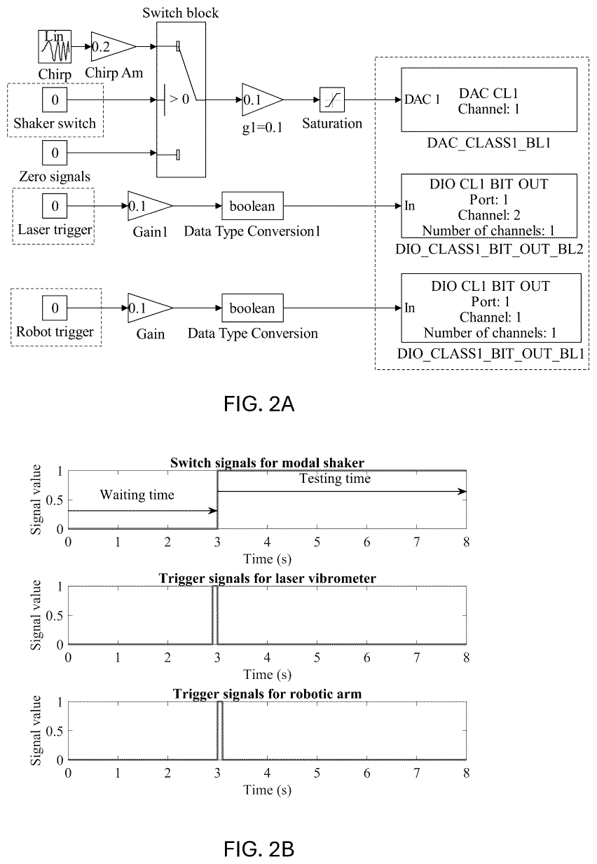

The working principle of the central control and DAQ system via Simulink is illustrated in FIG. 2A. The control model comprises three tracks corresponding to the modal shaker, the laser vibrometer, and the robotic arm, respectively. Initial signals for the three blocks denoting shaker switch, laser trigger, and robot trigger, respectively, are all set to zero, and digital signals are applied to initiate vibration measurements. FIG. 2B provides an example of digital signals used during testing. In the top track of FIG. 2A, the modal shaker is controlled by a switch block. Its data inputs, shown in the first and third ports, are a series of excitation and zero signals, respectively. The control input, shown in the second port, has a threshold value of zero. Data are sent to the modal shaker via a digital-to-analog converter (DAC), shown at the right end of the top track. From FIG. 2B, the control input for the modal shaker consists of two phases: a waiting time and a testing time. During the waiting time, the control input signal remains zero, which does not meet the threshold; therefore, the switch block passes zero signals, and the modal shaker remains disabled. At the end of the waiting time, which is 3 seconds in this example, the signal value switches to one, meeting the threshold. As a result, the switch block passes excitation signals, which are chirp signals in this example, and the modal shaker is activated. The middle and bottom tracks in FIG. 2A show triggers for DAQ of the laser vibrometer and the movement of the robotic arm, respectively. Both tracks follow similar logic: a digital pulse is used as the trigger signal near the start of the testing time. The only difference is that the laser vibrometer is triggered by the falling edge of the pulse, while the robotic arm is triggered by the rising edge.

### 1.2 Scan Path Design and Response Measurement

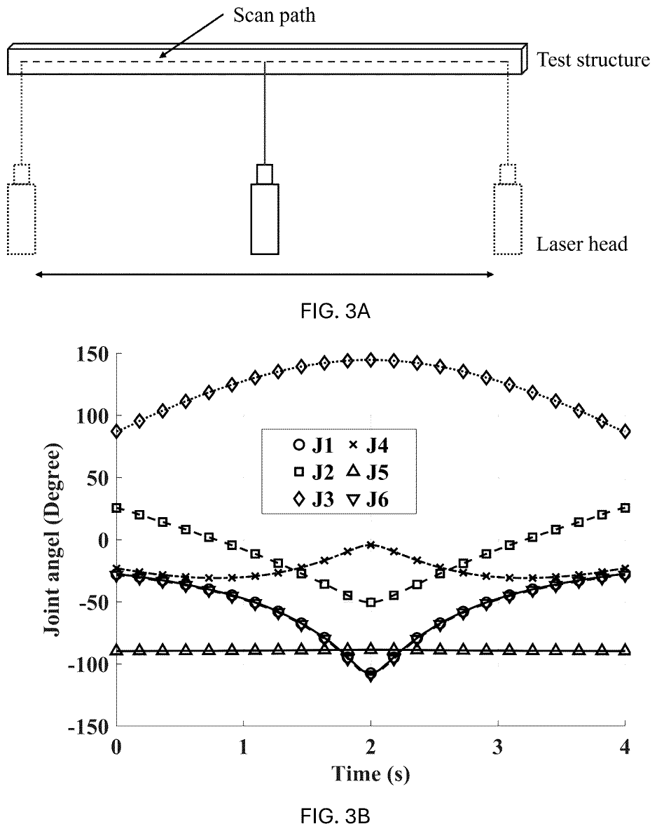

Continuous scanning measurements can be performed using the system described herein by continuously moving the laser vibrometer. This approach is significantly different from a conventional CSLDV system, which performs continuous scanning by rotating a pair of orthogonal scan mirrors. An example of using the robotic CSLDV system to scan a beam-like structure is shown in FIG. 3A, where the laser vibrometer is translated along a straight line on the surface of the beam at a constant speed. A complete scan is defined as the laser spot moving from the start point to the end point and then returning. The period of one scan is denoted as T, and the scan frequency is given by f_{sc}=1/T. The distance between the laser head and the surface of the test beam remains constant during scanning, indicating that the tool center point (TCP) of the system follows a linear trajectory.

Kinematics of the robotic CSLDV system described herein can be described using the Denavit-Hartenberg (DH) convention [31],

$${}_{la}^{0} T = {T}_{1}^{0} {T}_{2}^{1} {T}_{3}^{2} {T}_{4}^{3} {T}_{5}^{4} {T}_{6}^{5} {T}_{la}^{6} \qquad ( 1 )$$

where

$${}_{la}^{0} T$$

denotes the transformation matrix describing the pose of the laser spot, which is an end-effector in this work, relative to the base of the system,

$${T}_{i}^{i - 1}$$

denotes the relative pose of the i^{th} joint to the (i−1)^{th} joint, and

$${T}_{la}^{6}$$

represents the pose of the laser spot relative to joint 16. Each

$${T}_{i}^{i - 1}$$

is determined by DH parameters, including link lengths a, link offsets d, link twists α, and joint angles θ. The first three parameters are known from the robotic arm's physical configuration.

$${T}_{la}^{6}$$

can be determined from the laser head geometry and its distance to the test structure. Inverse kinematics (IK) based on DH parameters of the system is used to calculate its joint angles θ as

$${θ}_{i} = {f}^{- 1} ( {}_{la}^{0} P ) \qquad ( 2 )$$

where

$${}_{la}^{0} P$$

denotes the position of the laser spot in the base coordinate system.

In this example, a commercial Collaborative robot (Cobot) model DOBOT CR5A (Shenzhen Dobot Corp Ltd) and its control software, DobotStudio, are used to solve the IK equations and obtain joint angles. As a Cobot, the CR5A allows teaching by manually guiding the end-effector to the desired start and end points of the scan path in drag mode. These positions are recorded and used as input parameters for the IK. The joint rotation angles for a straight-line path at f_{sc}=0.25 Hz are shown in FIG. 3B. The joint J6 exhibits the largest rotation of 80.1 degrees from start to end, while the joint J5 rotates by only 1 degree. To maintain a constant TCP speed, each joint rotates at a different rate.

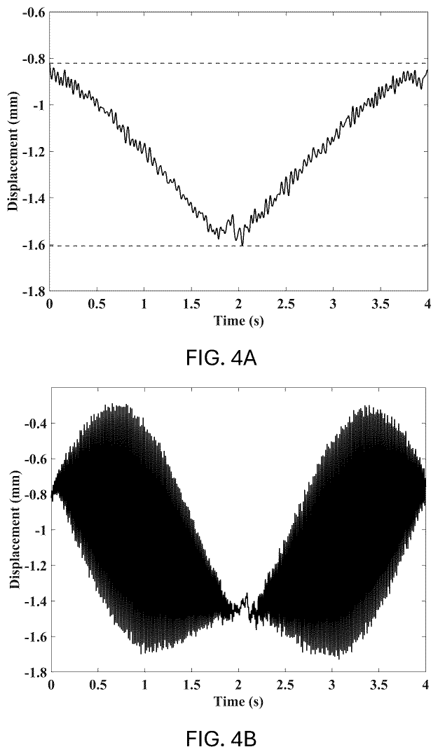

The response of the beam without excitation, as shown in FIG. 4A, is measured using the displacement-based laser vibrometer in the system to verify the scan path. The measured response has an amplitude of less than 0.8 mm, as indicated by the dashed lines, suggesting that the distance between the start and end points is also less than 0.8 mm. Given the beam length of 548 mm, the angle error between the actual and designed scan paths is approximately 0.08 degrees, indicating high accuracy in laser spot positioning. The response of the beam under sinusoidal excitation at 66.67 Hz, which is close to the first natural frequency of the beam, is shown in FIG. 4B. The system captures both the low-frequency motion of the laser head and the high-frequency vibration of the beam, demonstrating an advantage of the displacement-based laser vibrometer over conventional velocity-based models.

### 1.3 Signal Processing for Modal Identification

In conventional CSLDV measurements, the output response of a structure is a vibration signal modulated by spatial deflection due to continuous scanning motion [9]. When a straight-line scan trajectory is used to direct the laser spot across the structure, the response distribution u(x, t) can be expressed as

$$u ( x , t ) = {U}_{I} ( x ) cos ( {ω}_{e} t ) + {U}_{Q} ( x ) sin ( {ω}_{e} t ) \qquad ( 3 )$$

where U_{I}(x) and U_{Q}(x) represent in-phase (real) and the quadrature (imaginary) components of the mode shape of the structure, de is the excitation frequency, and x denotes the spatial coordinate along the scan path, normalized within [−1,1]. For a CSLDV measurement with a uniform scanning rate, this spatially varying response can be expressed purely as a function of time [10]:

$$u ( t ) = {U}_{I} ( t ) cos {ω}_{e} t + {U}_{Q} ( t ) sin {ω}_{e} t \qquad ( 4 )$$

To extract U_{I} and U_{Q}, the response is multiplied by cosine and sine functions of the excitation frequency, yielding:

$$\begin{matrix}u ( t ) cos {ω}_{e} t = {U}_{I} ( t ) {cos}^{2} {ω}_{e} t + {U}_{Q} ( t ) sin {ω}_{e} t cos {ω}_{e} t \\ = \frac{1}{2} {U}_{I} ( t ) + \frac{1}{2} {U}_{I} ( t ) cos 2 {ω}_{e} t + \frac{1}{2} {U}_{Q} ( t ) sin 2 {ω}_{e} t\end{matrix} \qquad ( 5 )$$

$$\begin{matrix}u ( t ) sin {ω}_{e} t = {U}_{I} ( t ) cos {ω}_{e} t sin {ω}_{e} t + {U}_{Q} ( t ) {sin}^{2} {ω}_{e} t \\ = \frac{1}{2} {U}_{Q} ( t ) + \frac{1}{2} {U}_{I} ( t ) sin 2 {ω}_{e} t - \frac{1}{2} {U}_{Q} ( t ) cos 2 {ω}_{e} t\end{matrix} \qquad ( 6 )$$

Signal components with frequency 2ωₑ can be removed by applying a low-pass filter, and scaling the filtered signals by a factor of 2 yields the desired mode shape components.

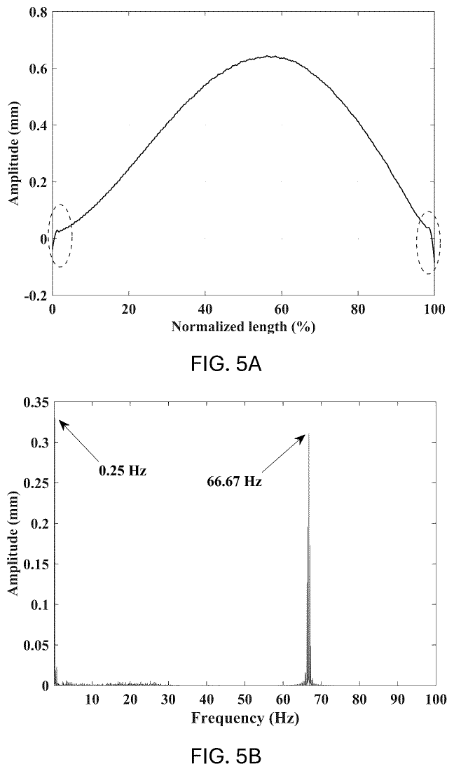

This method is referred to as demodulation, as it separates the vibration signal from spatial modulation effects. To test the applicability of the demodulation method to the robotic CSLDV system described herein, it was used to process the response shown in FIG. 4B. As seen in FIG. 5A, the resulting first mode shape of the beam is not smooth and exhibits noticeable boundary distortions, as highlighted by dashed circles, differing significantly from results obtained using the conventional CSLDV [32]. To investigate the cause of this inaccuracy, a frequency spectrum of the measured response was obtained using a fast Fourier transform (FFT), as shown in FIG. 5B. The spectrum displays two dominant peaks at 0.25 Hz and 66.67 Hz, corresponding to the laser head motion and the beam vibration, respectively. The proximity of the low-frequency motion signal to zero frequency reduces the effectiveness of the low-pass filter in the demodulation method, resulting in inaccurate mode shape identification.

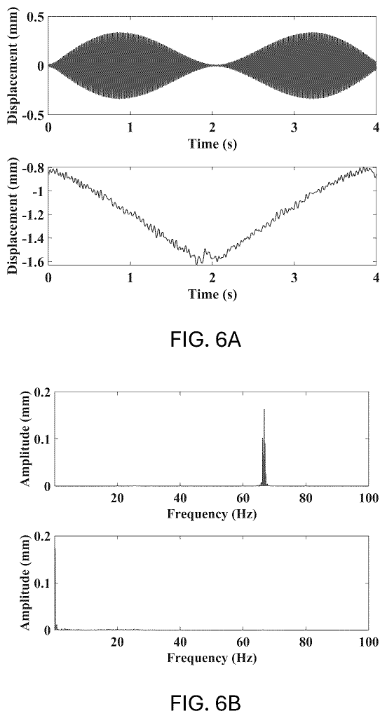

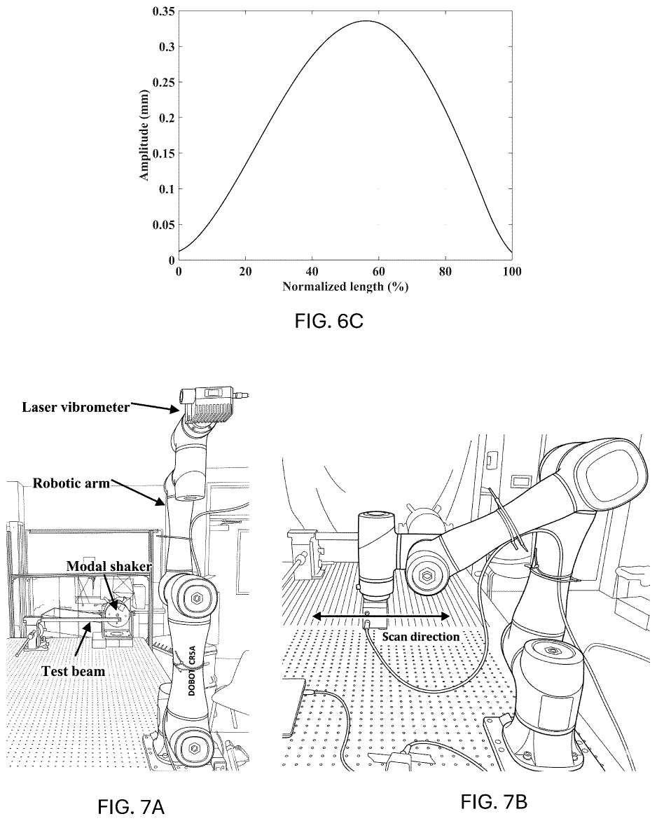

To overcome this limitation, a notch-filter-enhanced demodulation (NFED) method is disclosed herein. In this method, notch filters are applied to the measured response to isolate the low-frequency laser head motion and high-frequency beam vibration. Center frequencies of the notch filters are set to the scan and excitation frequencies, respectively. A narrow band-width of 0.01 Hz is used to ensure selectivity for the low-frequency component. Separated signals are shown in FIG. 6A, with the top subplot showing the beam vibration and the bottom subplot showing the laser head motion. Their respective frequency spectra are provided in FIG. 6B, each exhibiting a single prominent peak. With the beam vibration signal filtered, its mode shape can be accurately extracted using the demodulation method, as shown in FIG. 6C. This enhancement addresses limitations of the conventional demodulation approach for the robotic CSLDV system.

### 2. Experimental Investigation

### 2.1 Experimental Setup

In this section, a series of experiments were conducted to validate the robotic CSLDV system for modal identification of a beam under sinusoidal excitation. The experimental setup is shown in FIG. 7, where FIG. 7A displays the initial position of the robotic CSLDV system, and FIG. 7B shows the test position. The six-axis robotic arm used is the DOBOT CR5A model (Shenzhen Dobot Corp. Ltd., Shenzhen, China), and the laser vibrometer is the MotionGo model (OmniSensing Photonics LLC, Maryland, USA). A machined flange was used to connect the vibrometer to the robotic arm. The payload capacity of the CR5A is 5,000 g, while the total weight of the MotionGo vibrometer and the flange is 530 g, which is well within the payload limit of the robotic arm.

In the system's initial position, where the rotation angles of all six joints are set to zero, the laser beam is parallel to the beam surface, meaning that the test beam lies outside the FOV of the system. This configuration is difficult to measure using the conventional CSLDV. The test beam is clamped at one end in a bench vise and excited at the other end using a modal shaker driven by a sinusoidal signal with a frequency of 66.67 Hz, which is close to its first natural frequency. In the test position, the laser head moves along the scan direction shown in FIG. 7B, which is parallel to the beam surface. The total scan length is 548 mm, and the joint angles for this scanning motion are identical to those shown in FIG. 3A.

### 2.2 Experimental Validation

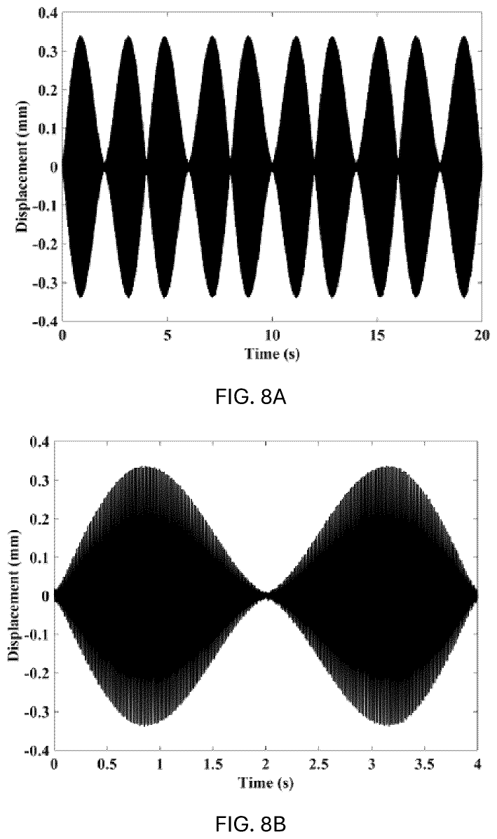

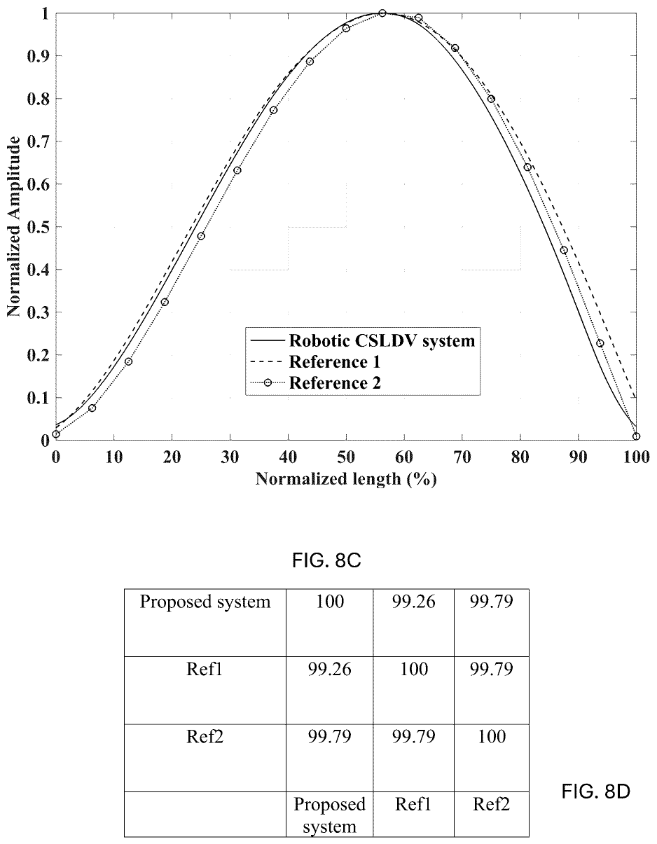

In this experiment, the running speed of the system was set to 274 mm/s, corresponding to a scan frequency of 0.25 Hz. Five complete scans, taking a total of 20 s, were conducted. Vibration signals of the beam, separated from the measured response using the NFED method, are shown in FIG. 8A. An averaging technique was applied to the vibration signals to obtain the response from one complete scan, as shown in FIG. 8B. This averaged signal was used to extract the mode shape of the beam using the NFED method. In addition, two reference experiments were conducted to validate the mode shape identified by the robotic CSLDV system. The first reference experiment, referred to as reference 1, used the conventional CSLDV with the same scan frequency of 0.25 Hz. The second reference experiment, referred to as reference 2, used the robotic CSLDV system in a point-by-point scanning mode, where the system paused at each point for measurement before moving to the next one.

FIG. 8C compares the first mode shapes of the beam obtained from all three experiments, where the solid line denotes the first mode shape of the beam identified using the robotic CSLDV system, the dashed line denotes that identified using the conventional CSLDV, and the line with circular markers denotes that identified using the point-by-point method. The mode shape identified by the robotic CSLDV system described herein closely matches those from both reference experiments. To quantitatively evaluate the correlation among the identified mode shapes, MAC values were calculated. A MAC value close to 100% indicates strong correlation between two mode shapes, while a value near 0 indicates weak correlation. The resulting MAC matrix is shown in FIG. 8D. The off-diagonal MAC values between the mode shape identified by the robotic CSLDV system described herein and those from the two reference experiments are both greater than 99%, confirming the high consistency among them. Comparison among test duration, number of measurement points, and availability beyond the FOV of the three measurement systems is shown in Table 1. While all three methods achieve comparable accuracy in identifying the mode shape of the beam, the robotic CSLDV system offers an extended FOV compared to the conventional CSLDV and reduced test duration with higher spatial resolution compared to the point-by-point method.

TABLE 1
Comparison among test duration, number of measurement points, and
availability beyond the FOV of the three measurement systems.

| | Test | Number of | Availability |
|---|---|---|---|
| | duration | measurement | beyond the |
| System | (s) | points | FOV |
| Robotic CSLDV | 20 | 80,000 | Yes |
| Conventional CSLDV | 20 | 80,000 | No |
| Single-point CSLDV | 101 | 17 | No |

### 3. Discussion

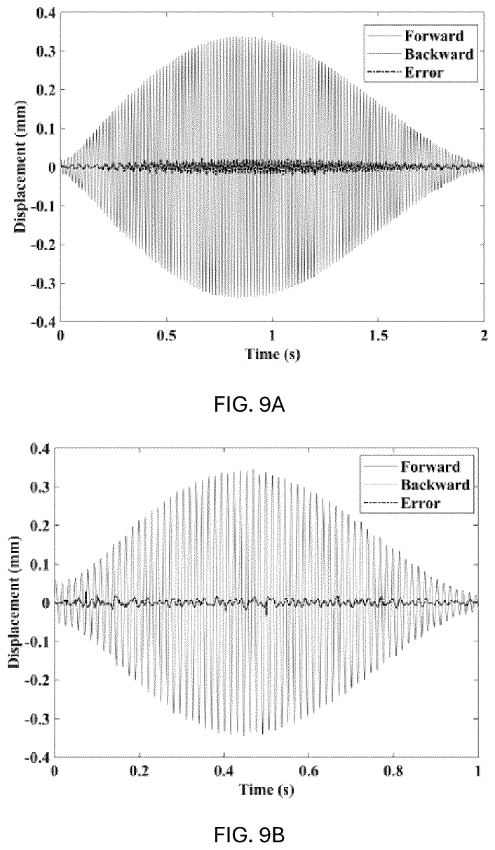

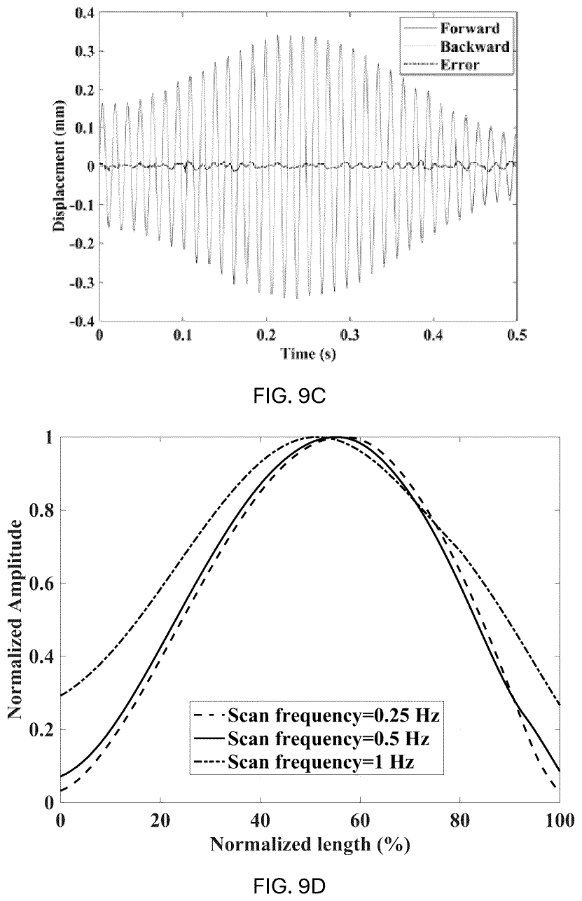

In this section, the effect of the system's running speed on the identified mode shape of the beam is discussed. Three comparison experiments were conducted using the proposed system and the NFED method to identify the first mode shape of the beam. Running speeds were set to 274 mm/s, 548 mm/s, and 1096 mm/s, corresponding to scan frequencies of 0.25 Hz, 0.5 Hz, and 1 Hz, respectively. A speed accuracy study was conducted first to investigate the consistency between forward and backward scans in a scan period at different scan speeds, as shown in FIGS. 9A-C, where errors indicate differences between responses captured by the robotic CSLDV system described herein during its forward scans and those during its backward scans. It can be seen that responses of forward and backward scans have good agreement for all three cases, and errors between them are small. Standard deviation values of errors for the three cases are 0.0058 mm, 0.0068 mm, and 0.0054 mm, respectively. It can be concluded that the consistency between forward and backward scans of the robotic CSLDV system is not affected by the running speed of the system.

The identified mode shapes of the beam for these scan frequencies are shown in FIG. 9D, where the dashed line represents the mode shape at the scan frequency of 0.25 Hz, the solid line at the scan frequency of 0.5 Hz, and the dash-dotted line at the scan frequency of 1 Hz. The mode shape at the scan frequency of 0.25 Hz, validated in Section 2, is used as the reference for comparison. The mode shapes identified at scan frequencies of 0.25 Hz and 0.5 Hz are similar, with a MAC value greater than 99% between them. However, the mode shape at the scan frequency of 1 Hz shows significant deviation, particularly near the beam boundaries. The MAC value between mode shapes at scan frequencies of 0.25 Hz and 1 Hz drops to 95%. It is worth noting that in conventional CSLDV measurements [6, 13], identified mode shapes are generally unaffected by the scan frequency of the system. One possible reason for the reduced accuracy at the higher running speed, which is greater than half the speed limit of the robotic arm, is the noise introduced by the robotic arm's motion.

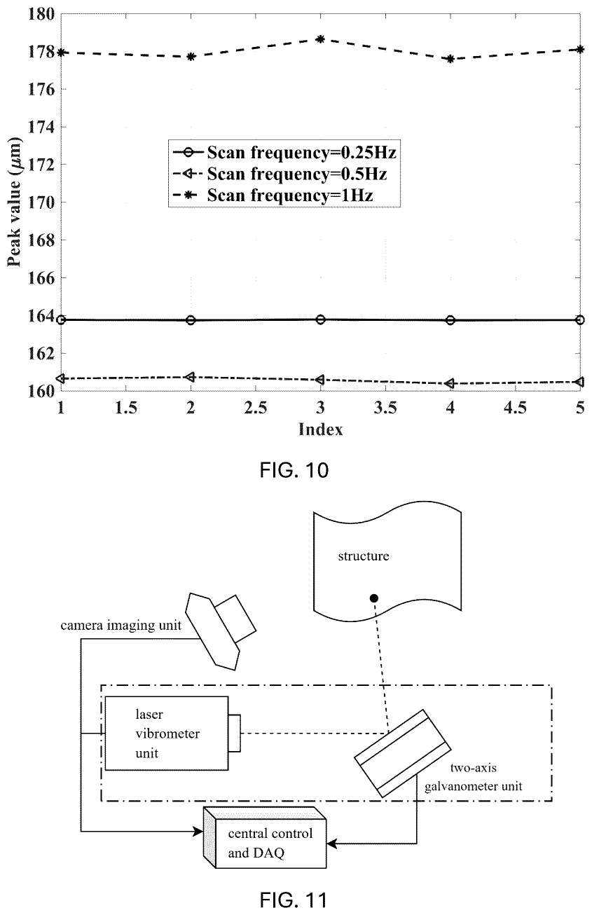

A repeatability study was also conducted for the three scan frequency cases in the frequency domain. As five complete scans were performed for each case, frequency spectra were obtained using the FFT method (not shown). Peak values from the spectra of each scan were extracted and plotted in FIG. 10D. As the running speed increases, peak values show more fluctuation. Standard deviation values of peak amplitudes for the three cases are 0.015 μm, 0.14 μm, and 0.41 μm, respectively. These results indicate that the repeatability of the robotic CSLDV system described herein decreases as the running speed increases. The reduced accuracy observed at 1 Hz may arise from vibration transmission through the robotic joints, mechanical backlash, and servo control dynamics when the arm approaches its speed limit. These effects can increase low-frequency motion noise in the measured signals, thereby reducing the accuracy of mode shape identification.

### 4. Conclusions

A novel robotic CSLDV system, which integrates a six-axis robotic arm and a compact laser vibrometer, was developed to measure structural vibrations with high spatial resolution and scanning flexibility. An NFED method was introduced to separate structural vibration signals from the motion-induced components of the laser vibrometer. Experimental validation and comparative studies were carried out to assess the accuracy and repeatability of the system in identifying beam mode shapes under sinusoidal excitation. In summary:
1. A robotic CSLDV system was developed to perform continuous scanning along arbitrary paths via robot arm motion, offering extended FOV compared to conventional CSLDV systems using scanning mirrors.
2. A new NFED method was introduced, enabling accurate extraction of structural vibration signals even when robotic motion introduces noise close to zero frequency in the measurement signal.
3. Experimental validation confirmed high accuracy of the robotic CSLDV system: the identified first mode shape of a cantilever beam matched well with reference measurements, with MAC values exceeding 99% compared to conventional CSLDV and point-by-point methods.
4. Scan speed affects mode shape accuracy: Mode shapes identified at 0.25 Hz and 0.5 Hz scan frequencies were consistent, while performance degraded at 1 Hz, with MAC dropping to 95% due to increased noise from robotic motion.
5. Repeatability decreases at higher scan speeds: Spectral peak amplitude fluctuations and standard deviation values increased with scan frequency, indicating a trade-off between scanning speed and measurement consistency.

### Example 2

### 1. System Description

This example relates to a CSLDV system based on an interpolated mapping between image pixel coordinates and galvanometer coordinates. This robotic CSLDV system comprises a laser vibrometer, e.g., a laser Doppler vibrometer unit, a two-axis galvanometer unit, a camera imaging unit, and a control and processing unit, as shown in FIG. 11. Although a robotic arm is not shown in FIG. 11, the laser vibrometer unit and the two-axis galvanometer unit are attached to the end of the robotic arm, either directly to the mounting flange at the end of the robotic arm or indirectly attached to a mounting bracket or fixture assembly which is attached to the end of the robotic arm. In FIG. 11, the dot-dash box encircling the laser vibrometer and the galvanometer unit is intended to designate the units attached to the robotic arm. The positioning of each of these units is readily determined by the person skilled in the art.

In some embodiments, the robotic CSLDV system comprising a galvanometer does not require the use a modal shaker, instead measuring a structure's vibrations without intentionally causing it to vibrate. That said, it should be appreciated by the person skilled in the art that the robotic CSLDV system comprising a galvanometer can include a modal shaker under certain circumstances.

The laser vibrometer unit is configured to emit a measurement laser beam and receive scattered optical signals returned from the surface of a structure to be measured, so as to output vibration response signals corresponding to the laser irradiation position. The two-axis galvanometer unit is arranged along the laser propagation path and is configured to deflect the laser beam in three dimensions such that the laser beam moves over the surface of the measured object along a predetermined trajectory, both for processing measurements obtained on straight scan paths to estimate 1D modal parameters as well as using a 2D scan scheme that can let a CSLDV system scan its whole surface. In some embodiments, the 2D scan scheme sweeps a laser spot along a zigzag scan path on at least a portion of a surface of the RS to measure vibration of the RS. The camera imaging unit is configured to capture images of the measured object and the laser spot, thereby obtaining the pixel position of the laser spot in an image. The central control DAQ unit is connected to the robotic arm and its controller, the laser vibrometer, the two-axis galvanometer unit, and the camera imaging unit, and is configured to control the motion of the robotic arm, the laser vibrometer, galvanometer motion, acquire images, extract the spot center, establish a mapping relationship between pixel coordinates and galvanometer coordinates, generate galvanometer driving commands according to a target pixel trajectory, and associate vibration signals with scanning positions.

### 2. Coordinate Mapping and Calibration Process

In this example, the galvanometer control coordinates are denoted as g=(x_{g}, y_{g}), and the pixel coordinates of the laser spot in the camera image are denoted as p=(u, v). Under the condition that the installation state of the system, the camera field of view, the galvanometer position, and the pose of the measured object remain unchanged, and the measured region of the structure is a low-curvature, approximately planar region, the galvanometer coordinates and the image pixel coordinates form a stable two-dimensional mapping relationship. The control strategy of this example is based on experimentally establishing the correspondence between the galvanometer coordinates and the pixel coordinates of the observed laser spot, so that the required galvanometer coordinates for a target pixel position can be obtained directly from the mapping relationship.

The central control and DAQ unit performs a calibration process as follows. First, during calibration, the relative positions of the laser vibrometer unit, e.g., a laser Doppler vibrometer, the two-axis galvanometer unit, the camera imaging unit, and the measured object are maintained fixed, and a working region on the measured object is determined. Next, a plurality of sampling points is selected within the available working range of the two-axis galvanometer to form a galvanometer coordinate sample set {gᵢ=(x_{g,i}, Y_{g,i})}, i=1, 2, . . . , N. The two-axis galvanometer is then controlled to move sequentially to the sampling points so that the laser beam is directed to different positions on the surface of the measured object, while the camera imaging unit captures corresponding images. For each image, laser spot recognition and center localization are performed to obtain a corresponding pixel coordinate set {pᵢ=(uᵢ, vᵢ)}, i=1, 2, . . . , N. Based on the sample pairs {(gᵢ, pᵢ)}, a forward mapping from galvanometer coordinates to pixel coordinates, p=F(g), and/or an inverse mapping from pixel coordinates to galvanometer coordinates, g=G(p), is established. The mapping relationship may be constructed using two-dimensional interpolation, piecewise interpolation, spline interpolation, radial basis function fitting, lookup-table interpolation, or a combination thereof. Preferably, the inverse mapping g=G(p) is directly established for control inversion.

The laser spot center in the image acquired by the camera imaging unit may be obtained through threshold segmentation, region extraction, centroid calculation, Gaussian fitting, ellipse fitting, or sub-pixel center localization. To improve mapping accuracy, multiple frames acquired under the same galvanometer coordinate may be averaged during calibration, and galvanometer feedback coordinates may be used instead of nominal command coordinates as the mapping input, thereby reducing the influence of galvanometer dynamic error, image noise, and spot detection error on the calibration result.

### 3. Scan Path Design and Response Measurement

After calibration is completed, the control and processing unit performs a continuous scanning measurement process. First, a target measurement region is determined in the camera image, and a target scanning pixel trajectory p_{d}(t)=(u_{d}(t), v_{d}(t)) or its discrete sequence {p_{d,k}} is defined. Then, according to the established inverse mapping relationship, a corresponding galvanometer control trajectory g_{d,k}=G(p_{d,k}) is calculated. The galvanometer control trajectory is subsequently subjected to smoothing, boundary checking, and dynamic constraint processing to generate executable galvanometer driving commands. Finally, the two-axis galvanometer is controlled according to the driving commands so that the laser beam continuously moves over the surface of the measured object along positions corresponding to the target pixel trajectory, while the laser Doppler vibrometer unit acquires vibration response signals in real time during the scanning process.

Accordingly, the technical scheme of this example can be summarized as follows: the pixel position of the laser spot is obtained through camera imaging; an experimental mapping relationship between pixel coordinates and galvanometer control coordinates is established through sampling; the target scanning trajectory in the image is converted directly into a galvanometer driving trajectory based on the mapping relationship; and, in combination with synchronous acquisition of laser Doppler vibration signals, continuous scanning vibration measurement of a low-curvature approximately planar target region on a structure is achieved.

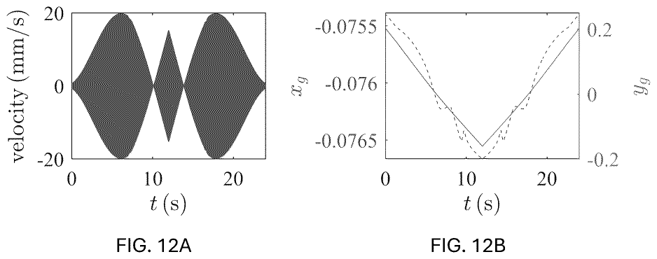

As shown in FIG. 12A, when the beam specimen is scanned continuously along the prescribed straight-line path under sinusoidal excitation at 80 Hz, the measured velocity response varies with time, indicating that the moving laser spot samples different positions of the structure during the scan. The corresponding galvanometer coordinates used to generate this straight-line path are shown in FIG. 12B. It can be seen that the two-axis galvanometer evolves synchronously to maintain the desired scanning trajectory in the image plane. In particular, the y-coordinate exhibits the dominant variation along the path, while the x, coordinate undergoes a comparatively small adjustment to compensate for the coordinate mapping and ensure that the laser spot follows the prescribed straight line. These results demonstrate that the robotic CSLDV system comprising a galvanometer is able to convert a predefined image-space path into executable galvanometer motions and simultaneously acquire the vibration response along that path.

Once the structure is scanned using the robotic CSLDV system comprising a galvanometer and a measured response obtained, notch filters are applied to the measured response to isolate the low-frequency laser head motion and high-frequency beam vibration. Once the beam vibration signal filtered, its mode shape can be accurately extracted using a demodulation method.

The robotic CSLDV system comprising a galvanometer is intended as an optional extension of the robotic CSLDV system without galvanometer described herein, rather than a replacement for it. The purpose of incorporating the mirror and galvanometer is not to diminish the advantages of the robotic arm, but to complement them. The robotic arm provides large-range positioning capability and flexible access in three-dimensional space, which is advantageous for extending the measurement field of view and reaching different test regions. The galvanometer provides much faster local beam steering within a given robot pose, enabling rapid continuous scanning over a smaller area.

Although the invention has been variously disclosed herein with reference to illustrative embodiments and features, it will be appreciated that the embodiments and features described hereinabove are not intended to limit the invention, and that other variations, modifications and other embodiments will suggest themselves to those of ordinary skill in the art, based on the disclosure herein. The invention therefore is to be broadly construed, as encompassing all such variations, modifications and alternative embodiments within the spirit and scope of the claims hereafter set forth.

### REFERENCES

[1] A. Stanbridge, D. Ewins, A review of 10 years of continuous-scan LDV developments, in: Proceedings of international conference on noise and vibration engineering ISMA2006, Vol. 1, 2006, p. 8.
[2] D. Di Maio, P. Castellini, M. Martarelli, S. Rothberg, M. Allen, W. Zhu, D. Ewins, Continuous scanning laser vibrometry: A raison d′être and applications to vibration measurements, Mechanical Systems and Signal Processing 156 (2021) 107573. doi: 10.1016/j.ymssp.2020.107573.
[3] P. Chiariotti, M. Martarelli, P. Castellini, Exploiting continuous scanning laser Doppler vibrometry in timing belt dynamic characterisation, Mechanical Systems and Signal Processing 86 (2017) 66-81. doi: 10.1016/j.ymssp.2016.01.001.
[4] P. Chiariotti, M. Martarelli, P. Castellini, Mode matching of continuous scanning laser Doppler vibration data in the frequency domain, Optics and Lasers in Engineering 107 (2018) 231-240. doi: 10.1016/j.optlaseng.2018.03.034.
[5] S. Yang, M. S. Allen, Output-only modal analysis using continuous-scan laser Doppler vibrometry and application to a 20 kW wind turbine, Mechanical Systems and Signal Processing 31 (2012) 228-245. doi: 10.1016/j.ymssp.2012.04.012.
[6] D.-M. Chen, Y. Xu, W. Zhu, Damage identification of beams using a continuously scanning laser Doppler vibrometer system, Journal of Vibration and Acoustics 138 (5) (2016) 051011. doi: 10.1115/1.4033639.
[7] D.-M. Chen, Y. Xu, W. Zhu, A comprehensive study on detection of hidden delamination damage in a composite plate using curvatures of operating deflection shapes, Journal of Nondestructive Evaluation 38 (2019) 1-18. doi: 10.1007/s10921-019-0591-8.
[8] L. Lyu, K. Yuan, W. Zhu, A novel demodulation method with a reference signal for operational modal analysis and baseline-free damage detection of a beam under random excitation, Journal of Sound and Vibration 571 (2024) 118068. doi: 10.1016/j.jsv. 2023.118068.
[9] P. Sriram, S. Hanagud, J. Craig, Mode shape measurement using a scanning laser Doppler vibrometer, The International Journal of Analytical and Experimental Modal Analysis 7 (3) (1992) 169-178.
A. Stanbridge, D. Ewins, Modal testing using a scanning laser Doppler vibrometer, Mechanical Systems and Signal Processing 13 (2) (1999) 255-270. doi: 10.1006/mssp.1998.1209.
M. S. Allen, M. W. Sracic, A new method for processing impact excited continuous-scan laser Doppler vibrometer measurements, Mechanical Systems and Signal Processing 24 (3) (2010) 721-735. doi: 10.1016/j.ymssp.2009.11.004.
Y. Xu, D.-M. Chen, W. Zhu, Damage identification of beam structures using free response shapes obtained by use of a continuously scanning laser Doppler vibrometer system, Mechanical Systems and Signal Processing 92 (2017) 226-247. doi: 10.1016/j.ymssp.2016.12.042.
K. Yuan, W. Zhu, Estimation of modal parameters of a beam under random excitation using a novel 3D continuously scanning laser Doppler vibrometer system and an extended demodulation method, Mechanical Systems and Signal Processing 155 (2021) 107606. doi: 10.1016/j.ymssp.2021.107606.
L. F. Lyu, W. D. Zhu, Operational modal analysis of a rotating structure subject to random excitation using a tracking continuously scanning laser Doppler vibrometer via an improved demodulation method, Journal of Vibration and Acoustics 144 (1) (2021) 011006. doi: 10.1115/1.4051178.
Y. Chen, A. Escalera Mendoza, D. Griffith, Experimental dynamic characterization of both surfaces of structures using 3d scanning laser Doppler vibrometer, Experimental Techniques 47 (5) (2023) 989-1006. doi: 10.1007/s40799-022-00604-2.
B. Witt, D. Rohe, T. Schoenherr, Full-field strain shape estimation from 3D SLDV, in: Rotating Machinery, Optical Methods & Scanning LDV Methods, Volume 6: Proceedings of the 37th IMAC, A Conference and Exposition on Structural Dynamics 2019, Springer, 2019, pp. 31-45. doi: 10.1007/978-3-030-12935-4_4.
K. Yuan, W. Zhu, A novel mirror-assisted method for full-field vibration measurement of a hollow cylinder using a three-dimensional continuously scanning laser Doppler vibrometer system, Mechanical Systems and Signal Processing 216 (2024a) 111428. doi: 10.1016/j.ymssp.2024.111428.
K. Yuan, S. Yuan, W. Zhu, Full-field modal analysis of a tensegrity column using a three-dimensional scanning laser Doppler vibrometer with a mirror, Journal of Vibration and Acoustics 146 (6) (2024b) 061101. doi: 10.1115/1.4067079.
D. S. Gadiraju, S. E. Azam, D. Khazanchi, Shm-traffic: Drl and transfer learning based uav control for structural health monitoring of bridges with traffic, IEEE Access 13 (2025) 6166-6179. doi: 10.1109/ACCESS.2025.3526193.
E. Jeong, J. Seo, J. Wacker, New bridge inspection approach with joint uav and dic system, in: Structures Congress 2020, American Society of Civil Engineers Reston, V A, 2020, pp. 349-359. doi: 10.1061/9780784482896.033.
G. Lavezzi, M. Ciarci a, K. Won, M. Tazarv, A dic-uav based displacement measurement technique for bridge field testing, Engineering Structures 308 (2024) 117951. doi: 10.1016/j.engstruct.2024.117951.
P. Garg, F. Moreu, A. Ozdagli, M. R. Taha, D. Mascareñas, Noncontact dynamic displacement measurement of structures using a moving laser doppler vibrometer, Journal of Bridge Engineering 24 (9) (2019) 04019089. doi: 10.1061/(ASCE) BE.1943-5592.0001472.
P. Garg, R. Nasimi, A. Ozdagli, S. Zhang, D. D. L. Mascarenas, M. Reda Taha, F. Moreu, Measuring transverse displacements using unmanned aerial systems laser doppler vibrometer (uas-ldv): Development and field validation, Sensors 20 (21) (2020) 6051. doi: 10.3390/s20216051.
L. Bertini, P. Neri, C. Santus, A. Guglielmo, Automated experimental modal analysis of bladed wheels with an anthropomorphic robotic station, Experimental Mechanics 57 (2017) 273-285. doi: 10.1007/s11340-016-0223-5.
O. Devigne, S. Hoffait, O. Bruls, Development of a robot-aided modal analysis measurement method using laser doppler vibrometry, in: ISMA 2020 (29th Leuven Conference on Noise and Vibration Engineering), 2020, pp. 1847→1858.
H. Ahmed, A. Mohsin, S.-C. Hong, J.-R. Lee, J.-B. Ihn, Robotic laser sensing and laser mirror excitation for pulse-echo scanning inspection of fixed composite structures with non-planar geometries, Measurement 176 (2021) 109109. doi: 10.1016/j. measurement.2021.109109.
K. F. Brethee, A. N. Uwayed, A. Y. Alden Qwam, A novel index for vibration-based damage detection technique in laminated composite plates under forced vibrations: Experimental study, Structural Health Monitoring 22 (5) (2023) 3109-3125. doi: 10.1177/14759217221145622.
P. Margerit, T. Gobin, A. Lebée, J.-F. Caron, The robotized laser doppler vibrometer: On the use of an industrial robot arm to perform 3d full-field velocity measurements, Optics and Lasers in Engineering 137 (2021) 106363. doi: 10.1016/j.optlaseng.2020.106363.
Y. Zeng, A. Nunez, Z. Li, Speckle noise reduction for structural vibration measurement with laser doppler vibrometer on moving platform, Mechanical Systems and Signal Processing 178 (2022) 109196. doi: 10.1016/j.ymssp.2022.109196.
K. Yuan, Z. Zhu, W. Chen, W. Zhu, Development and validation of a new type of displacement-based miniatured laser vibrometers, Sensors 24 (16) (2024) 5230. doi: 10.3390/s24165230.
J. Denavit, R. S. Hartenberg, A kinematic notation for lower-pair mechanisms based on matrices, Journal of Applied Mechanics 22 (2) (2021) 215-221. doi: 10.1115/1.4011045.
D.-M. Chen, Y. F. Xu, W. D. Zhu, Experimental investigation of notch-type damage identification with a curvature-based method by using a continuously scanning laser Doppler vibrometer system, J. Nondestruct. Eval. 36 (2) (2017) 38.
D. J. Ewins, Modal Testing: Theory, Practice and Application, Engineering dynamics series, Wiley, 2000.
Di Maio, D., and Ewins, D., Continuous scan, a method for performing modal testing using meaningful measurement parameters; Part I, Mech. Syst. Signal Process. 25(8) (2011), pp. 3027-3042.
Xu, Y. F., Chen, D. M., and Zhu, W. D., Modal parameter estimation using free response measured by a continuously scanning laser Doppler vibrometer system with application to structural damage identification, J. Sound Vib. 485 (2020), p. 115536.
Yang, S., and Allen, M. S., Lifting approach to simplify output-only continuous-scan laser vibrometry, Mech. Syst. Signal Process. 45(2) (2014), pp. 267-282.
Xu, Y. F., Chen, D. M., and Zhu, W. D., Operational modal analysis using lifted continuously scanning laser Doppler vibrometer measurements and its application to baseline-free structural damage identification, J. Vib. Control. 25(7) (2019), pp. 1341-1364.

What is claimed is:

1. A robotic continuously scanning laser vibrometer (CSLV) system, said system comprising:
a robotic arm;
a laser vibrometer mounted on the robotic arm; and
a central control and data acquisition (DAQ) system.

2. The robotic CSLV system of claim 1, wherein the CSLV system is a continuously scanning laser Doppler vibrometer (CSLDV) system.

3. The robotic CSLV system of claim 1, wherein the robotic arm is a six-axis robotic arm.

4. The robotic CSLV system of claim 1, further comprising a modal shaker, wherein the modal shaker comprises an element to attach a structure thereto.

5. The robotic CSLV system of claim 1, wherein the central control and DAQ system comprises electronics to control a modal shaker, the laser vibrometer, and the robotic arm.

6. The robotic CSLV system of claim 5, wherein the modal shaker is controlled by a switch block.

7. The robotic CSLV system of claim 6, wherein the switch block controls data to the modal shaker via a digital-to-analog (DAC) converter, wherein the modal shaker is disabled when the switch block passes zero signals and the modal shaker vibrates when the switch block passes excitation signals.

8. The robotic CSLV of claim 4, wherein movement of the robotic arm, data acquisition of the laser vibrometer, and excitation provided by a modal shaker are synchronized by the central control and DAQ system.

9. The robotic CSLV of claim 8, wherein the excitation is sinusoidal.

10. The robotic CSLV of claim 1, further comprising a two-axis galvanometer device mounted on the robotic arm and a camera imaging unit, optionally mounted on the robotic arm.

11. A method of obtaining a mode shape of a structure using the robotic CSLV system of claim 1, said method comprising:
scanning a vibrating structure using the robotic CSLV system, wherein the laser vibrometer is translated along a straight line on a surface of the structure to obtain a measured response of the structure under sinusoidal excitation;
separating the measured response to isolate a low-frequency laser head motion signal from a high-frequency structure vibration signal using a notch filter;
extracting the structure vibration signal to obtain its mode shape.

12. The method of claim 11, further comprising attaching the structure to a modal shaker to vibrate the structure prior to scanning.

13. The method of claim 12, wherein the vibrating is effected using sinusoidal excitation.

14. The method of claim 11, wherein a distance of the laser vibrometer and the surface of the structure remains constant during scanning.

15. The method of claim 11, wherein the scanning is performed at a constant speed.

16. The method of claim 11, wherein the scanning has a scan frequency in a range of about 0.25 Hz to about 1 Hz.

17. The method of claim 11, wherein the central control and DAQ system captures both a low-frequency motion of the laser vibrometer and a high-frequency vibration of the structure.

18. The method of claim 11, wherein the robotic CSLDV system further comprises a two-axis galvanometer device mounted on the robotic arm and a camera imaging unit, optionally mounted on the robotic arm, wherein the two-axis galvanometer is controlled so that the laser beam continuously moves over the surface of the structure along positions corresponding to the target pixel trajectory, while the laser vibrometer acquires vibration response signals in real time during scanning.

19. The method of claim 11, wherein the robotic CSLDV system offers an extended field-of-view (FOV) and reduced test duration with higher spatial resolution compared to a point-by-point CSLDV method.

20. A method of detecting damage in a structure, said method comprising using the mode shape obtained according to the method of claim 11, using the robotic CSLV system, to identify damage to the structure.
